(19) United States
(12) Patent Application Publication
(10) Pub. No.: US 2025/0324187 A1
(43) Pub. Date: Oct. 16, 2025

(54) A HEARING DEVICE

(71) Applicant: GN HEARING A/S, Ballerup (DK)

(72) Inventors: Seven HUANG, Ballerup (DK); Frank LIN, Ballerup (DK); Jon Grane MASDEN, Ballerup (DK); Bill ZENG, Ballerup (DK); Jack ZHAO, Ballerup (DK)

(21) Appl. No.: 18/869,944

(22) PCT Filed: May 30, 2022
(86) PCT No.: PCT/CN2022/096069

§ 371 Date: Nov. 27, 2024

(51) Int. Cl. H04R 1/10; H04R 1/08

(52) U.S. Cl. CPC H04R 1/1066; H04R 1/083; H04R 1/1008; H04R 1/105

(57) ABSTRACT

AMENDMENTS TO THE ABSTRACT

Please amend the Abstract of the Disclosure as follows:

Disclosed is a hearing device. The hearing device is configured to be worn on a user's head. The hearing device comprises a first earpiece configured to be worn at an ear of the user. The first earpiece comprises a primary surface . The primary surface is configured to face the user's ear when the user is wearing the hearing device in its intended position. The hearing device further comprises an earpiece support. The earpiece support is configured to rest on the user's head. The earpiece support has a first end and a second end. The first earpiece is pivotably attached to the first end of the earpiece support by means of a first pivot hinge, such that a distance (A) from the first pivot hinge to the primary surface of the first earpiece is in the range of about 5 mm to 15 mm. Thereby an even distribution of a clamping force is applied on the primary surface of the first earpiece when the user is wearing the hearing device in its intended position.

### FIELD

The present invention relates to a hearing device. More specifically, the disclosure relates to a hearing device configured to be worn on a user's head and comprising a first earpiece and an earpiece support.

### BACKGROUND

Over the past years, various types of headsets have been developed. A popular type of headset comprises a pair of headphones and a headband connecting the pair of headphones. Another popular type of headset comprises a headphone and a headband. A user of such headset wears the headband on her/his head and places the headphone or the headphones at her/his ear or ears, respectively. However, such headset may not fit well to different users, as the users may have different ear shapes e.g. different ear angles with respect to their face. In addition, the user of such headset may find it uncomfortable to continuously wear the headset for a long time, as the headphone may apply a pressure to the user's ear and head. Thus, there is a need for an improved hearing device that addresses the abovementioned problems.

### SUMMARY

Disclosed is a hearing device. The hearing device is configured to be worn on a user's head. The hearing device comprises a first earpiece. The first earpiece is configured to be worn at a first ear of the user. The first earpiece comprises a primary surface. The primary surface of the first earpiece is configured to face the user's first ear when the user is wearing the hearing device in its intended position. The hearing device further comprises an earpiece support. The earpiece support is configured to rest on the user's head. The earpiece support has a first end and a second end. The first earpiece is pivotably attached to the first end of the earpiece support by means of a first pivot hinge such that a distance (A) from the first pivot hinge to the primary surface of the first earpiece is in the range of about 5 mm to 15 mm. Thereby an even distribution of a clamping force is applied on the primary surface of the first earpiece when the user is wearing the hearing device in its intended position. The hearing device may be a mono hearing device comprising one earpiece. The hearing device may be a mono headset comprising one earpiece. The first earpiece may be an earphone or a headphone. The first earpiece may be configured to be arranged at the user's ear, on the user's ear, over the user's ear or around the user's ear. The first earpiece may be configured to be arranged in contact with the user's ear. The primary surface of the first earpiece may partly cover the user's ear when the user is wearing the hearing device in its intended position. The primary surface of the first earpiece may completely cover the user's ear when the user is wearing the hearing device in its intended position. The primary surface of the first earpiece may also cover a portion of the user's skin around the user's ear when the user is wearing the hearing device in its intended position.

The first earpiece may comprise an output transducer e.g. an speaker. The first earpiece may comprise a signal processor. The first earpiece may comprise a control unit. The first earpiece may comprise an antenna. The first earpiece may comprise an input transducer e.g. a microphone. The first earpiece may comprise a rechargeable battery. The first earpiece may comprise a wired connection. The first earpiece may comprise an active noise cancellation (ANC) unit. The first earpiece may comprise proximity sensors e.g. for on/off ear detection. The first earpiece may comprise accelerometers. The first earpiece may comprise biometric sensors. The first earpiece may comprise wireless charging circuits/coils. The first earpiece may comprise a housing such that the output transducer, the signal processor, the control unit, the antenna, the input transducer, the rechargeable battery, the wired connection, the ANC unit, the proximity sensors, the accelerometers, the biometric sensors, and the wireless charging circuits/coils may be arranged inside the housing.

The earpiece support may be a headband. The earpiece support may be made of any material. For instance, the earpiece support may be made of any of or any combination of polymer, plastic or metal. The earpiece support may be flexible. The earpiece support may be rigid.

The first earpiece is pivotably attached to the first end of the earpiece support by means of a first pivot hinge. Thereby, this allows for rotation of the first earpiece with respect to the earpiece support and hence provides an improved mono hearing device in terms of flexibility and comfort. This is because the first earpiece rotates with respect to the earpiece support and hence can adapt to the user's ear angle. Therefore, the hearing device fits different user's ear angle with respect to the earpiece support.

The distance (A) from the first pivot hinge to the primary surface of the first earpiece is in the range of about 5 mm to 15 mm. The distance (A) from the first pivot hinge to the primary surface of the first earpiece is in the range of about 7 mm to 13 mm. The distance (A) from the first pivot hinge to the primary surface of the first earpiece is in the range of about 9 mm to 11 mm. This distance (A) is shorter, compared to the conventional hearing devices having a distance of 25 mm to 50 mm. The distance (A) of about 5 mm to 15 mm allows for moving the first pivot hinge i.e. the rotation center of the first earpiece closer to the primary surface of the first earpiece. Thereby, the distance (A) of about 5 mm to 15 mm allows for providing an even more flexible and comfortable mono hearing device. In addition, the distance (A) of about 5mm to 15 mm allows for providing an even better fit for different users e.g. a more secure fit with an improved sealing between the primary surface of the first earpiece and the user's ear. Thereby, the distance (A) of about 5 mm to 15 mm allows for an even distribution of the clamping force and hence an even distribution of pressure applied on the primary surface of the first earpiece when the user is wearing the hearing device in its intended position.

An example of advantages of such secure fit with an improved sealing is that even when the user of the mono hearing device bends forward, backward or rotates her/his head, the mono hearing device stably stays on the user's ear i.e. does not slide or fall off. Another example of advantages of such secure fit with an improved sealing is that there is no need to increase the clamping force on the primary surface of the first earpiece by e.g. making a tighter earpiece support, as the inventive concept allows for providing enough clamping force and enough rotation torque for the first earpiece. An advantage of having enough clamping force, having enough rotation torque and having an even distribution of the clamping force applied on the primary surface of the first earpiece, when the user is wearing the hearing device in its intended position, is that the user may feel less that she/he is wearing a hearing device. Therefore, the user may wear the mono hearing device for a longer period of time e.g. without feeling tired.

In an embodiment, the hearing device may be arranged at the user's ear, on the user's ear, over the user's ear i.e., the hearing device is configured to be worn on, over and/or at the user's ear.

The hearing device may be a hearable such as a, headphone, hearing aid, a personal sound amplification product (PSAP), an over-the-counter (OTC) hearing device, a hearing protection device, a one-size-fits-all hearing device, a custom hearing device or another head-wearable hearing device.

The hearing device may be configured for audio communication, e.g. enabling the user to listen to media, such as music or radio, and/or enabling the user to perform phone calls. The hearing device may be configured for performing hearing compensation for the user. The hearing device may be configured for performing noise cancellation etc.

The hearing device may be embodied in various housing styles or form factors. Some of these form factors are on the ear headphones or over the ear headphones. The person skilled in the art is well aware of different kinds of hearing devices and of different options for arranging the hearing device on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHZ, preferably a wavelength between 900 MHz and 6 GHz. The first frequency may be 902 MHz to 928 MHz. The first frequency may be 2.4 to 2.5 GHZ. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the hearing device may include a processing unit. The processing unit may be configured for processing the first and/or second electric input signal(s). The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

In some embodiments, the hearing device may further comprise a second earpiece. The second earpiece may be configured to be worn at a second ear of the user. The second earpiece may comprise a primary surface. The primary surface may be configured to face the user's second ear when the user is wearing the hearing device in its intended position. The second earpiece may be pivotably attached to the second end of the earpiece support by means of a second pivot hinge. A distance (A) from the second pivot hinge to the primary surface of the second earpiece may be in the range of about 5 mm to 15 mm. Thereby, an even distribution of a clamping force may be applied on the primary surface of the second earpiece when the user is wearing the hearing device in its intended position.

The hearing device may be a duo/stereo hearing device comprising a first earpiece and a second earpiece. The hearing device may be a duo/stereo headset comprising a first earpiece and a second earpiece. The second earpiece may be an earphone or a headphone. The second earpiece may be configured to be arranged on the second ear of the user. The second earpiece may be configured to be arranged in contact with the second ear of the user. The primary surface of the second earpiece may partly cover the second ear of the user when the user is wearing the hearing device in its intended position. The primary surface of the second earpiece may completely cover the second ear of the user when the user is wearing the hearing device in its intended position. The primary surface of the second earpiece may also cover a portion of the user's skin around the second ear of the user when the user is wearing the hearing device in its intended position.

The second earpiece may comprise an output transducer e.g. an speaker. The second earpiece may comprise a signal processor. The second earpiece may comprise a control unit. The second earpiece may comprise an antenna. The second earpiece may comprise an input transducer e.g. a microphone. The second earpiece may comprise a rechargeable battery. The second earpiece may comprise a wired connection. The second earpiece may comprise an active noise cancellation (ANC) unit. The second earpiece may comprise proximity sensors e.g. for on/off ear detection. The second earpiece may comprise accelerometers. The second earpiece may comprise biometric sensors. The second earpiece may comprise wireless charging circuits/coils. The second earpiece may comprise a housing such that the output transducer, the signal processor, the control unit, the antenna, the input transducer, the rechargeable battery, the wired connection, the ANC unit, the proximity sensors, the accelerometers, the biometric sensors, and the wireless charging circuits/coils may be arranged inside the housing. The second earpiece may be identical to the first earpiece. The second earpiece may not be identical to the first earpiece.

The second earpiece may be pivotably attached to the second end of the earpiece support by means of a second pivot hinge. Thereby, this may allow for rotation of the second earpiece with respect to the earpiece support and may hence provide an improved duo/stereo hearing device in terms of flexibility and comfort. This is because the second earpiece may also rotate with respect to the earpiece support and may hence adapt to the user's ear angle. Therefore, the hearing device may fit different user's ear angle with respect to the earpiece support.

The distance (A) from the second pivot hinge to the primary surface of the second earpiece is in the range of about 5 mm to 15 mm. This distance (A) is shorter, compared to the conventional hearing devices having a distance of 25 mm to 50 mm. The distance (A) of about 5 mm to 15 mm may allow for moving the second pivot hinge i.e. the rotation center of the second earpiece closer to the primary surface of the second earpiece. Thereby, the distance (A) of about 5 mm to 15 mm may allow for providing an even more flexible and comfortable duo/stereo hearing device. In addition, the distance (A) of about 5 mm to 15 mm may allow for providing an even better fit for different users e.g. a more secure fit with an improved sealing between the primary surface of the second earpiece and the user's ear. Thereby, the distance (A) of about 5 mm to 15 mm may allow for an even distribution of the clamping force and hence an even distribution of pressure applied on the primary surface of the second earpiece when the user is wearing the hearing device in its intended position.

An example of advantages of such secure fit with an improved sealing is that even when the user of the duo/stereo hearing device bends forward, backward or rotates her/his head, the duo/stereo hearing device stably stays on the user's ear i.e. does not slide or fall off. Another example of advantages of such secure fit with an improved sealing is that there is no need to increase the clamping force on the primary surface of the second earpiece by e.g. making a tighter earpiece support, as the inventive concept allows for providing enough clamping force and enough rotation torque for the second earpiece. An advantage of having enough clamping force, having enough rotation torque and having even distribution of the clamping force applied on the primary surface of the second earpiece, when the user is wearing the duo/stereo hearing device in its intended position, is that the user may feel less that she/he is wearing a hearing device. Therefore, the user may wear the duo/stereo hearing device for a longer period of time e.g. without feeling tired. A further advantage of such duo/stereo hearing device is that there may be 50% clamping force on each ear of the user. Therefore, the user may feel equal clamping force and hence equal pressure on her/his ears.

The earpiece support may connect the first earpiece and the second earpiece. The earpiece support may extend between the first earpiece and the second earpiece.

In some embodiments, the first earpiece may comprise a first cushion. The first cushion may have a first surface configured to face the user's first ear when the user is wearing the hearing device in its intended position. In some embodiments, the second earpiece may comprise a second cushion. The second cushion may have a first surface configured to face the user's second ear when the user is wearing the hearing device in its intended position. The first surface of the first cushion and the first surface of the second cushion may be the primary surfaces. The first cushion may be configured to be arranged on the user's ear. The first cushion may be configured to be arranged in contact with the user's ear. The first surface of the first cushion may partly cover the user's ear when the user is wearing the hearing device in its intended position. The first surface of the first cushion may completely cover the user's ear when the user is wearing the hearing device in its intended position. The first surface of the first cushion may also cover a portion of the user's skin around the user's ear when the user is wearing the hearing device in its intended position. The first cushion may have a second surface. The second surface of the first cushion may be arranged opposite to the first surface of the first cushion. An example of advantages of the first cushion may be that it may provide a more smooth surface and hence more comfort to the user of the mono hearing device or to the user of the duo/stereo hearing device.

The second cushion may be configured to be arranged on the second ear of the user. The second cushion may be configured to be arranged in contact with the user's second ear. The first surface of the second cushion may partly cover the user's second ear when the user is wearing the hearing device in its intended position. The first surface of the second cushion may completely cover the user's second ear when the user is wearing the hearing device in its intended position. The first surface of the second cushion may also cover a portion of the user's skin around the user's ear when the user is wearing the hearing device in its intended position. The second cushion may have a second surface. The second surface of the second cushion may be arranged opposite to the first surface of the second cushion. An example of advantages of the second cushion may be that it may provide more a smooth surface and hence more comfort to the user of the duo/stereo hearing device.

In some embodiment, the first earpiece may comprise a first connecting element and the first pivot hinge may be attached to the first connecting element of the first earpiece. The first connecting element may have an angle (α) in the range of about 15 degrees to 90 degrees with respect to the primary surface of the first cushion. In some embodiments, the second earpiece may comprise a second connecting element and the second pivot hinge may be attached to the second connecting element of the second earpiece. The second connecting element may have an angle (α) in the range of about 15 degrees to 90 degrees with respect to the primary surface of the second cushion.

The first connecting element may have an angle (α) in the range of about 15 degrees to 90 degrees with respect to the primary surface of the first earpiece. Thereby, the angle (α), in the range of about 15 degrees to 90 degrees, between the first connecting element and the primary surface of the first earpiece or the primary surface of the first cushion, may facilitate providing the distance (A), in the range of about 5 mm to 15 mm, from the first pivot hinge to the primary surface of the first earpiece or the primary surface of the first cushion. Thereby, the angle (α) between the first connecting element and the primary surface of the first earpiece or the primary surface of the first cushion may facilitate providing enough clamping force and the even distribution of the clamping force on the primary surface of the first earpiece or the primary surface of the first cushion when the user is wearing the hearing device in its intended position. The second connecting element may have an angle (α) in the range of about 15 degrees to 90 degrees with respect to the primary surface of the second earpiece. Thereby, the angle (α), in the range of about 15 degrees to 90 degrees, between the second connecting element and the primary surface of the second earpiece or the primary surface of the second cushion may facilitate providing the distance (A), in the range of about 5 mm to 15 mm, from the second pivot hinge to the primary surface of the second earpiece or the primary surface of the second cushion. Thereby, the angle (α) between the second connecting element and the primary surface of the second earpiece or the primary surface of the second cushion may facilitate providing enough clamping force and the even distribution of the clamping force on the primary surface of the second earpiece or the primary surface of the second cushion when the user is wearing the hearing device in its intended position.

In some embodiments, the first pivot hinge may comprise a first stopping element. The first stopping element may be configured to limit rotation of the first earpiece around the first pivot hinge. In some embodiments, the second pivot hinge may comprise a second stopping element. The second stopping element may be configured to limit rotation of the second earpiece around the second pivot hinge.

Thereby, the first stopping element and the second stopping element may allow for a limited rotation of the first earpiece and the second earpiece around the respective first pivot hinge and the second pivot hinge. Hence, the first stopping element and the second stopping element may allow for providing a flexible mono or duo/stereo hearing device. In addition, the limited rotation of the first earpiece and the second earpiece around the respective first pivot hinge and the second pivot hinge may be desired for some users. Hence, the first stopping element and the second stopping element may allow for providing a user-friendly mono or duo/stereo hearing device. The hearing device may only comprise the first stopping element. The hearing device may only comprise the second stopping element. The hearing device may comprise both the first stopping element and the second stopping element.

In some embodiments, the first earpiece may be configured to rotate around the first pivot hinge with an angle (β) in the range of about −90 degrees to about 90 degrees. In some embodiments, the second earpiece may be configured to rotate around the second pivot hinge with an angle (β) in the range of about −90 degrees to about 90 degrees. Thereby, a more flexible hearing device may be provided, as some hearing devices may require the first earpiece to be configured to rotate around the first pivot hinge with an angle (β) in the range of about −90 degrees to about 90 degrees and/or the second earpiece to be configured to rotate around the second pivot hinge with an angle (β) in the range of about −90 degrees to about 90 degrees. The first earpiece may be configured to rotate around the first pivot hinge with an angle (β) in the range of about −20 degrees to about 90 degrees. In some embodiments, the second earpiece may be configured to rotate around the second pivot hinge with an angle (β) in the range of about −20 degrees to about 90 degrees.

In some embodiments, the first earpiece may comprise a first housing. The first connecting element may connect the first housing of the first earpiece and the earpiece support. In some embodiments, the second earpiece may comprise a second housing. The second connecting element may connect the second housing of the second earpiece and the earpiece support. The first housing may have a first surface. The first housing may have a second surface. The second surface of the first housing may be arranged opposite to the first surface. The first surface of the first housing may be configured to be attached to the second surface of the first cushion. The second surface of the housing may face the surrounding when the user is wearing the hearing device in its intended position.

The second housing may have a first surface. The second housing may have a second surface. The second surface of the second housing may be arranged opposite to the first surface. The first surface of the second housing may be configured to be attached to the second surface of the second cushion. The second surface of the housing may face the surrounding when the user is wearing the hearing device in its intended position.

The first housing and the second housing may be made of any of or any combination of polymer, plastic or metal. The first housing and the second housing may be identical and/or mirror symmetrical. The first housing and the second housing may be different.

In some embodiments, the hearing device may be an on-the-ear hearing device, an over-the-ear hearing device, or an around-the-ear hearing device. Thereby, the mono hearing device may be configured to be arranged on-the-ear of the user, over-the-ear of the user, or around-the-ear of the user. Thereby, the duo/stereo hearing device may be configured to be arranged on-the-ears of the user, over-the-ears of the user, or around-the-ears of the user.

In some embodiments, the hearing device may further comprise a microphone boom attached to the first housing of the first earpiece. In some embodiments, the hearing device may further comprise a microphone boom attached to the second housing of the second earpiece. The microphone boom may be attached to the second surface of the first housing. The microphone boom may be attached to the second surface of the second housing. The microphone boom may allow for more comfort to the user of the hearing device. The microphone boom may allow for a hearing device with improved functionality e.g. improved sound quality.

The present invention relates to the hearing device described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device 100.

FIG. 2 schematically illustrates the exemplary hearing device 100, shown in FIG. 1.

FIG. 3 schematically illustrates a magnified view of a part of the exemplary hearing device 100, shown by a circle in FIG. 2.

FIG. 4 schematically illustrates the part of the exemplary hearing device 100, shown in FIG. 3, viewed in a perpendicular direction.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

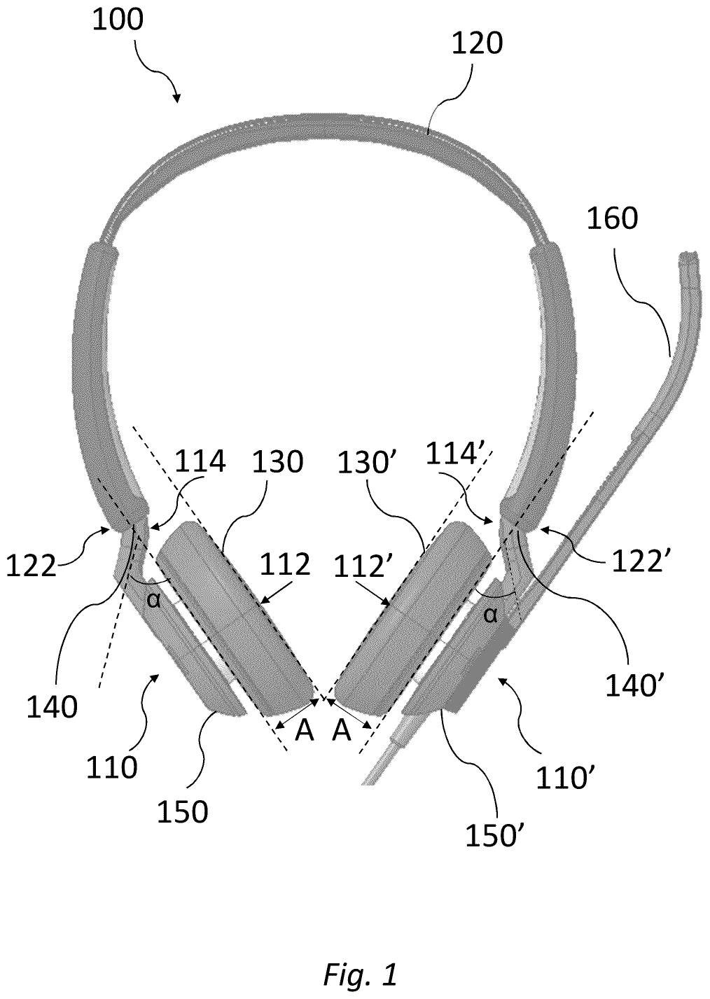

FIG. 1 illustrates an exemplary hearing device 100. The hearing device 100 shown in FIG. 1 is a duo/stereo hearing device 100. The hearing device 100 shown may be a mono hearing device 100. The hearing device 100 is configured to be worn on a user's head. FIG. 1 shows that the hearing device 100 comprises a first earpiece 110, configured to be worn at an ear of the user.

FIG. 1 shows that the hearing device 100 comprises a second earpiece 110′, configured to be worn at an ear of the user. FIG. 1 shows that each of the first earpiece 110 and the second earpiece 110′ comprises a primary surface 112, 112′. FIG. 1 shows that the primary surface 112, 112′ are configured to face the user's ear when the user is wearing the hearing device 100 in its intended position.

FIG. 1 further shows that the hearing device 100 comprises an earpiece support 120. FIG. 1 shows that the earpiece support 120 connects the first earpiece 110 and the second earpiece 110′. The earpiece support 120 is configured to rest on the user's head. The earpiece support 120 has a first end 122 and a second end 122′. The first earpiece 110 is pivotably attached to the first end 122 of the earpiece support 120 by means of a first pivot hinge 140. FIG. 1 shows that the second earpiece 110′ is pivotably attached to the second end 122′ of the earpiece support 120 by means of a second pivot hinge 140′. FIG. 1 shows that a distance (A) from each pivot hinge 140, 140′ to the primary surface 112, 112′ of the respective earpiece 110, 110′ is in the range of about 5 mm to 15 mm. Thereby an even distribution of a clamping force is applied on the primary surface 112 of the first earpiece 110 and on the primary surface 112′ of the second earpiece 110′ when the user is wearing the hearing device 100 in its intended position.

FIG. 1 further shows that the first earpiece 110 comprises a first cushion 130. FIG. 1 shows that the first cushion 130 has a first surface 112 configured to face the user's ear when the user is wearing the hearing device 100 in its intended position. FIG. 1 further shows that the second earpiece 110′ comprises a second cushion 130′. FIG. 1 shows that the second cushion 130′ has a first surface 112′ configured to face the user's second ear when the user is wearing the hearing device 100 in its intended position. FIG. 1 shows that the first surface 112 of the first cushion 130 and the first surface 112′ of the second cushion 130′ are the primary surfaces 112, 112′.

FIG. 1 further shows that the first earpiece 110 comprises a first connecting element 114, and the first pivot hinge 140 is attached to the first connecting element 114 of the first earpiece 110. FIG. 1 shows that the second earpiece 110′ comprises a second connecting element 114′ and the second pivot hinge 140′ is attached to the second connecting element 114′ of the second earpiece 110′. The first connecting element 114 may have an angle (α) in the range of about 15 degrees to 90 degrees with respect to the primary surface 112 of the first cushion 130. The second connecting element 114′ may have an angle (α) in the range of about 15 degrees to 90 degrees with respect to the primary surface 112′ of the second cushion 130′.

FIG. 1 also shows that the first earpiece 110 comprises a first housing 150. FIG. 1 shows that the first connecting element 114 connects the first housing 150 of the first earpiece 110 and the earpiece support 120. FIG. 1 also shows that the second earpiece 110′ comprises a second housing 150′. FIG. 1 shows that the second connecting element 114′ connects the second housing 150′ of the second earpiece 110′ and the earpiece support 120.

FIG. 1 also shows that the hearing device further comprises a microphone boom 160. FIG. 1 shows that the microphone boom 160 is attached to the second housing 150′ of the second earpiece 110′. Alternatively, the microphone boom 160 may be attached to the first housing 150 of the first earpiece 110.

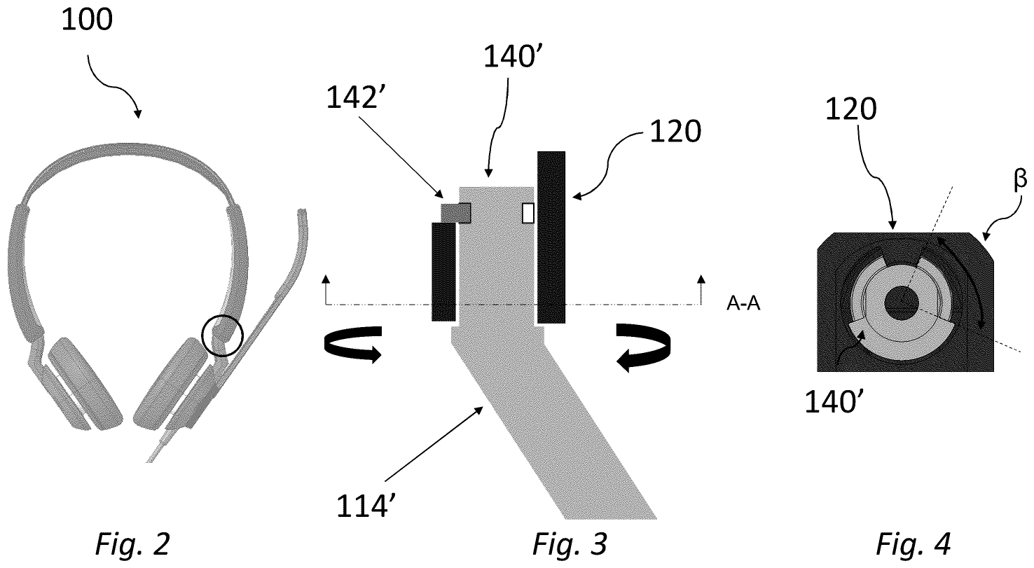

FIG. 2 schematically illustrates the exemplary hearing device 100, shown in FIG. 1. FIG. 3 schematically illustrates a magnified view of a part the exemplary hearing device 100, shown by a circle in FIG. 2.

FIG. 3 shows that the second pivot hinge 140′ is attached to the second connecting element 114′ of the second earpiece 110′. FIG. 3 further shows that the second pivot hinge 140′ comprises a second stopping element 142′. The second stopping element 142′ may be configured to limit rotation of the second earpiece 110′ around the second pivot hinge 140′. The arrows shown in FIG. 3 indicate the direction of the rotation of the second earpiece 110′ around the second pivot hinge 140′.

FIG. 4 schematically illustrates the part of the exemplary hearing device 100, shown in FIG. 3, viewed in a perpendicular direction. FIG. 4 shows a perpendicular view of the exemplary hearing device 100, shown in FIG. 3, at a line A-A shown in FIG. 3. As the line A-A is under the second stopping element 142′, the second stopping element 142′ is not visible in FIG. 4. The second earpiece 110′ may be configured to rotate around the second pivot hinge 140′ with an angle (β) in the range of about −90 degrees to about 90 degrees.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### ITEMS

1. A hearing device (100) configured to be worn on a user's head, the hearing device (100) comprising:
a first earpiece (110) configured to be worn at a first ear of the user, wherein the first earpiece (110) comprises a primary surface (112), the primary surface (112) being configured to face the user's first ear when the user is wearing the hearing device (100) in its intended position,
an earpiece support (120) being configured to rest on the user's head, the earpiece support (120) having a first end (122) and a second end (122′);
wherein the first earpiece (110) is pivotably attached to the first end (122) of the earpiece support (120) by means of a first pivot hinge (140), such that a distance (A) from the first pivot hinge (140) to the primary surface (112) of the first earpiece (110) is in the range of about 5 mm to 15 mm, thereby an even distribution of a clamping force is applied on the primary surface (112) of the first earpiece (110) when the user is wearing the hearing device (100) in its intended position.

2. The hearing device (100) according to item 1, the hearing device (100) further comprising:
a second earpiece (110′) configured to be worn at a second ear of the user, wherein the second earpiece (110′) comprises a primary surface (112′), the primary surface (112′) being configured to face the user's second ear when the user is wearing the hearing device (100) in its intended position,
wherein the second earpiece (110′) is pivotably attached to the second end (122′) of the earpiece support (120) by means of a second pivot hinge (140′), such that a distance (A) from the second pivot hinge (140′) to the primary surface (112′) of the second earpiece (110′) is in the range of about 5 mm to 15 mm, thereby an even distribution of a clamping force is applied on the primary surface (112′) of the second earpiece (110′) when the user is wearing the hearing device (100) in its intended position.

3. The hearing device (100) according to item 2, wherein the first earpiece (110) comprises a first cushion (130), the first cushion (130) having a first surface (112) configured to face the user's first ear when the user is wearing the hearing device (100) in its intended position,
wherein the second earpiece (110′) comprises a second cushion (130′), the second cushion (130′) having a first surface (112′) configured to face the user's second ear when the user is wearing the hearing device (100) in its intended position, and
wherein the first surface (112) of the first cushion (130) and the first surface (112′) of the second cushion (130′) are the primary surfaces (112, 112′).

4. The hearing device (100) according to item 3, wherein the first earpiece (110) comprises a first connecting element (114), and the first pivot hinge (140) is attached to the first connecting element (114) of the first earpiece (110),
wherein the second earpiece (110′) comprises a second connecting element (114′), and the second pivot hinge (140′) is attached to the second connecting element (114′) of the second earpiece (110′),
wherein the first connecting element (114) has an angle (α) in the range of about 15 degrees to 90 degrees with respect to the primary surface (112) of the first cushion (130) and
wherein the second connecting element (114′) has an angle (α) in the range of about 15 degrees to 90 degrees with respect to the primary surface (112′) of the second cushion (130′).

5. The hearing device (100) according to any of the preceding items, wherein the first pivot hinge (140) comprises a first stopping element (142), wherein the first stopping element (142) is configured to limit rotation of the first earpiece (110) around the first pivot hinge (140), wherein the second pivot hinge (140′) comprises a second stopping element (142′), wherein the second stopping element (142′) is configured to limit rotation of the second earpiece (110′) around the the second pivot hinge (140′).

6. The hearing device (100) according to item 5, wherein the first earpiece (110) is configured to rotate around the first pivot hinge (140) with an angle (β) in the range of about −90 degrees to about 90 degrees and wherein the second earpiece (110′) is configured to rotate around the second pivot hinge (140′) with an angle (β) in the range of about −90 degrees to about 90 degrees.

7. The hearing device (100) according to any of the items 4-6, wherein the first earpiece (110) comprises a first housing (150), wherein the first connecting element (114) connects the first housing (150) of the first earpiece (110) and the earpiece support (120), wherein the second earpiece (110′) comprises a second housing (150′), and wherein the second connecting element (114′) connects the second housing (150′) of the second earpiece (110′) and the earpiece support (120).

8. The hearing device (100) according to any of the preceding items, wherein the hearing device (100) is an on-the-ear hearing device, an over-the-ear hearing device, or an around-the-ear hearing device.

9. The hearing device (100) according to any of the item 7 or 8, wherein the hearing device further comprises a microphone boom (160) attached to the first housing (150) of the first earpiece (110) or attached to the second housing (150′) of the second earpiece (110′).

### LIST OF REFERENCES

100 Hearing device
112, 112′ First surface/primary surface
114 First connecting element
114 Second connecting element
110 First earpiece
110′ Second earpiece
120 Earpiece support
122 First end of the earpiece support
122 Second end of the earpiece support
130 First cushion
130 Second cushion
140 First pivot hinge
140 Second pivot hinge
142 First stopping element
142′ Second stopping element
150 First housing
150′ Second housing
160 Microphone boom

1. A hearing device configured to be worn on a user's head, the hearing device comprising:
a first earpiece configured to be worn at a first ear of the user, wherein the first earpiece comprises a primary surface, the primary surface being configured to face the user's first ear when the user is wearing the hearing device in its intended position,
an earpiece support being configured to rest on the user's head, the earpiece support having a first end and a second end;
wherein the first earpiece is pivotably attached to the first end of the earpiece support by means of a first pivot hinge, such that a distance from the first pivot hinge to the primary surface of the first earpiece is in the range of about 5 mm to 15 mm, thereby an even distribution of a clamping force is applied on the primary surface of the first earpiece when the user is wearing the hearing device in its intended position.

2. The hearing device according to claim 1, the hearing device further comprising:
a second earpiece configured to be worn at a second ear of the user,
wherein the second earpiece comprises a primary surface, the primary surface being configured to face the user's second ear when the user is wearing the hearing device in its intended position,
wherein the second earpiece is pivotably attached to the second end of the earpiece support by means of a second pivot hinge, such that a distance from the second pivot hinge to the primary surface of the second earpiece is in the range of about 5 mm to 15 mm, thereby an even distribution of a clamping force is applied on the primary surface of the second earpiece when the user is wearing the hearing device in its intended position.

3. The hearing device according to claim 2,
wherein the first earpiece comprises a first cushion, the first cushion having a first surface configured to face the user's first ear when the user is wearing the hearing device in its intended position,
wherein the second earpiece comprises a second cushion, the second cushion having a first surface configured to face the user's second ear when the user is wearing the hearing device in its intended position, and
wherein the first surface of the first cushion and the first surface of the second cushion are the primary surfaces.

4. The hearing device according to claim 3,
wherein the first earpiece comprises a first connecting element, and the first pivot hinge is attached to the first connecting element of the first earpiece,
wherein the second earpiece comprises a second connecting element, and the second pivot hinge is attached to the second connecting element of the second earpiece,
wherein the first connecting element has an angle in the range of about 15 degrees to 90 degrees with respect to the primary surface of the first cushion, and
wherein the second connecting element has an angle (α) in the range of about 15 degrees to 90 degrees with respect to the primary surface of the second cushion.

5. The hearing device according to claim 1,
wherein the first pivot hinge comprises a first stopping element, wherein the first stopping element is configured to limit rotation of the first earpiece around the first pivot hinge,
wherein the second pivot hinge comprises a second stopping element, and
wherein the second stopping element is configured to limit rotation of the second earpiece around the second pivot hinge.

6. The hearing device according to claim 5,
wherein the first earpiece is configured to rotate around the first pivot hinge with an angle in the range of about −90 degrees to about 90 degrees, and
wherein the second earpiece is configured to rotate around the second pivot hinge with an angle in the range of about −90 degrees to about 90 degrees.

7. The hearing device according to claim 4,
wherein the first earpiece comprises a first housing, wherein the first connecting element connects the first housing of the first earpiece and the earpiece support,
wherein the second earpiece comprises a second housing, and
wherein the second connecting element connects the second housing of the second earpiece and the earpiece support.

8. The hearing device according to claim 1, wherein the hearing device is an on-the-ear hearing device, an over-the-ear hearing device, or an around-the-ear hearing device.

9. The hearing device according to any of the claim 7, wherein the hearing device further comprises a microphone boom attached to the first housing of the first earpiece or attached to the second housing of the second earpiece.
